(19) United States
(12) Patent Application Publication
(10) Pub. No.: US 2013/0206505 A1
(43) Pub. Date: Aug. 15, 2013

(54) TOWER RESCUE EMERGENCY MODULE

(71) Applicant: Julien Tremblay, Trois-Rivieres (CA)

(72) Inventor: Julien Tremblay, Trois-Rivieres (CA)

(21) Appl. No.: 13/748,041

(22) Filed: Jan. 23, 2013

Related U.S. Application Data
(60) Provisional application No. 61/595,747, filed on Feb. 7, 2012.

(51) Int. Cl. A62B 1/00

(52) U.S. Cl. CPC A62B 1/00
USPC 182/18; 182/148

(57) ABSTRACT

An emergency rescue system for installation on tall buildings comprising an especially designed vertical rail on which a cab module moves up and down, propelled by a lightweight motor. The cab can hold over 1,000 pounds (e.g. six to seven persons). By itself, the cab weighs about 200 pounds and can be operated by a single person, is capable of moving very quickly, and preferably utilizes a small gasoline propelled engine.

### CROSS-REFERENCE TO RELATED APPLICATION

This application claims the benefit of co-pending provisional application Ser. No. 61/595,747, filed Feb. 7, 2012 and incorporated herein by reference.

### FIELD OF THE INVENTION

The present invention relates to an apparatus for emergency rescue operations at a multi-story building.

### BACKGROUND OF THE INVENTION

The Emporis Standards Committee defines a high-rise building as a multi-story structure “between 35 and 100 meters tall, or a building of unknown height from 12-39 floors” (Data Standards: high-rise building (ESN 8727) and a skyscraper as a multi-storey “building whose architectural height is at least 100 meters”). A loose convention of some in the United States and Europe draws the lower limit of a skyscraper at 150 meters (˜500 ft).

Most early high-rise buildings and skyscrapers emerged in the land-strapped areas of Chicago, London and New York toward the end of the 19^{th} century. Height limits and fire restrictions were soon introduced with rules that continued to exist with few exceptions until the 1950s. Concerns about aesthetics and fire safety had likewise hampered the development of skyscrapers across continental Europe for the first half of the 20^{th} century (Data Standards: skyscraper (ESN 24419), http://standards.emporis.com).

Chicago and New York competed for the title of “World's Tallest Building” and New York took the lead and by the early 1900s took the title of tallest building for many years. New York City developers competed among themselves with successively taller buildings claiming the title of “world's tallest” in the 1920s and early 1930s, culminating with the completion of the Chrysler Building in 1930 and the Empire State Building in 1931, the world's tallest building for forty years. The first completed World Trade Center tower became the world's tallest building in 1972. However it was soon overtaken by the Sears Tower (now the Willis Tower) in Chicago within two years. The Sears Tower stood as the world's tallest building for 24 years, from 1974 until 1998, until it was edged out by Petronas Twin Towers in Kuala Lampur, which held the title for six years. The world's tallest building is currently the Burj Khalifa in Dubai, United Arab Emirates, standing at 828 meters.

From the 1930s onwards, multi-story buildings and, in particular, skyscrapers, began to appear in Latin America, Asia, Africa, the Middle East and Oceania (mainly Australia). Momentum in setting records for the number of and for the world's tallest buildings increased and has continued until today.

Today, skyscrapers are an increasingly common sight where land is expensive, as in the centers of big cities, because they provide such a high ratio of rentable floor space per unit area of land. They are built not just for economy of space; like temples and palaces of the past, skyscrapers are considered symbols of a city's economic power. Not only do they define the skyline, they help to define the city's identity.

However, while not only have the buildings increased in height, their structure has changed so that a common feature of the new tall buildings is a steel framework, from which curtain walls are suspended, rather than load bearing walls of the conventional construction. Modern tall buildings and in particular skyscrapers are built with steel or reinforced concrete frameworks and curtain walls of glass or polished stone. They utilize mechanical equipment such as water pumps and elevators. Until the 19^{th} century, buildings of over six stories were rare, as having great numbers of stairs to climb was impractical for inhabitants, and water pressure was usually insufficient to supply running water above 50 m (164 ft).

The requirement of the number of stairs to climb and the inadequate water pressure made firefighting provisions inadequate and resulted mostly in poor results and loss of property and life.

The main objective of the instant invention is to provide an apparatus and a method for effectively carrying out emergency rescue operations at a multi-story building.

Prior art solutions to tower safety problems have employed a variety of apparatus and methods for evacuating occupants to safer locations. Pulley systems have been utilized wherein pulleys are attached to the building with closed loops of cable installed around the building. See, for example, FIG. 1 in each of issued U.S. Pat. Nos. 7,395,899 and 7,849,965, which are incorporated herein by reference.

Alternatively, Patent Publication No. 2007/0137928, also incorporated herein by reference, teaches rescuing a person attached to a plunger shaped body lowered from an upper level of a building through a vertical tube by using two different processes—low pressure at the entrance of the tube and a higher pressure at the exit of the tube using an airtight compartment and doors at one or both ends of the tube.

These prior systems are readily distinguishable from the subject invention having as its objects and advantages, those mentioned herein below.

### SUMMARY OF THE INVENTION

An apparatus, system and method of emergency rescue operations at a multi-story building are disclosed.

A fire fighting device for an installation for operation on tall buildings comprises an especially designed vertical rail on which a cab moves up and down propelled by a lightweight small motor. The vertical rail on which the cab moves is sometimes hereafter referred to as a “vertirail”. Typically, the cab can be configured to hold over 1,000 pounds (e.g. six to seven persons or equipment). By itself, the cab weighs about 200 pounds and can be operated by a single person, is capable of moving very quickly, and preferably utilizes a small gasoline propelled engine.

The system is configured to permit rapid intervention and rescue in case of disasters in buildings where otherwise not possible. The subject tower rescue emergency module (“T.R.E.M”) is a shuttle capable of attaining a height in excess of 600 meters and more. The height of the building as contemplated herein measures the height of the roof. Architectural detail, antenna and the like are not included in the heights expressed herein. Tower rescue shuttles permanently installed on various sides of a high-rise building, like lifeboats on a ship, can be used immediately when an alarm is sounded in a high-rise building.

In preferred embodiments, each tower rescue shuttle can transport six persons or two firemen and all of their equipment (maximum 450 kg). Alternative loading can include three stretchers for injured or handicapped individuals plus the operator can also be transported per trip. The tower rescue shuttle can rise as fast as 300 meters per minute.

The tower rescue shuttle can be installed on the vertirail by one person in less than 10 seconds. More than one vertirail and tower rescue shuttle can be installed on strategic points of high-rise buildings as necessary or desired. For best coverage it is preferred to install a complete system on each face of a building. Examples of different buildings designs that can benefit from the lifesaving benefits of the subject system include: office buildings, administrative buildings, commercial complexes, apartment buildings, hospitals, hotels, old age homes, condominiums, schools and various residences. The tower rescue system can also be used for working in high structures, electrical towers, communication and water towers, etc.

It will be recognized that the tower rescue system as herein disclosed will be particularly advantageous in situations where a high-rise fire is beyond the reach of an aerial ladder, and at such other times when an interior attack on a fire is not possible and there is no alternate plan.

A firefighter model tower rescue portable shuttle is also contemplated. The portable model may have a shuttle weight of 200 lbs., an ascending mode maximum load of 500 lbs., and a downward mode maximum load of about 1000 lbs. Three stretchers and one operator can use the shuttle at the same time. Typical shuttles use 6.5 hp to 10 hp Honda gas engines with electric starters.

All vertirails and wall-mount anchors are made of aluminum components and stainless steel fasteners.

A typical portable tower rescue shuttle uses a 6.5 hp to 10 hp Honda gas engine having a 12-volt electric starter and can be attached to the vertirail by one or two persons in less than 10 seconds and is easily removed from vertirail in a few seconds. Ascending speeds from 200 to 1000 feet per minute are typical and variable speed down can be controlled by gravity only. Optionally, a red strobe and a pair of wheels are installed under the shuttle.

In a typical permanent installation, the shuttle weighs about 200 lbs and its maximum load can be about 6 persons or 1,000 lbs. No motor is needed for the shuttle to function in a downward direction and variable downward speed is limited by gravity and a mechanical braking mechanism to adjust speed.

The shuttle system can automatically start itself when fire alarms are activated. A white strobe light is automatically activated with the fire alarm and turns off instantly when the shuttle is in the downward mode. A blue strobe lights under the Shuttle. The shuttle is easily removed from the vertical rail in a few seconds. The shuttles are made from aluminum and stainless steel.

The self-propelling and life-saving shuttle tower rescue system can be utilized on the outside of all buildings, and the system was developed to allow a fast intervention in case of disasters in buildings. This system comprises rescue shuttles capable of reaching heights of more than 400 meters and is contemplated for use in buildings of more than 600 meters in height.

Emergency responders as well as all those concerned about public and family fire safety issues will appreciate these improvements.

The subject improved tower rescue system may be made and used in accordance with the methods detailed below.

Other objects, features and advantages of the present invention will be apparent when the detailed descriptions of the preferred embodiments of the invention are considered with reference to the accompanying drawings, which should be construed in an illustrative and not limiting sense as follows.

### BRIEF DESCRIPTION OF THE DRAWINGS

FIGS. 1-2 are schematic drawings of a multi-story building incorporating apparatus of the present invention.

FIGS. 3-8 are details of embodiments of a rescue module.

FIG. 9 is a process diagram of one embodiment of the present method.

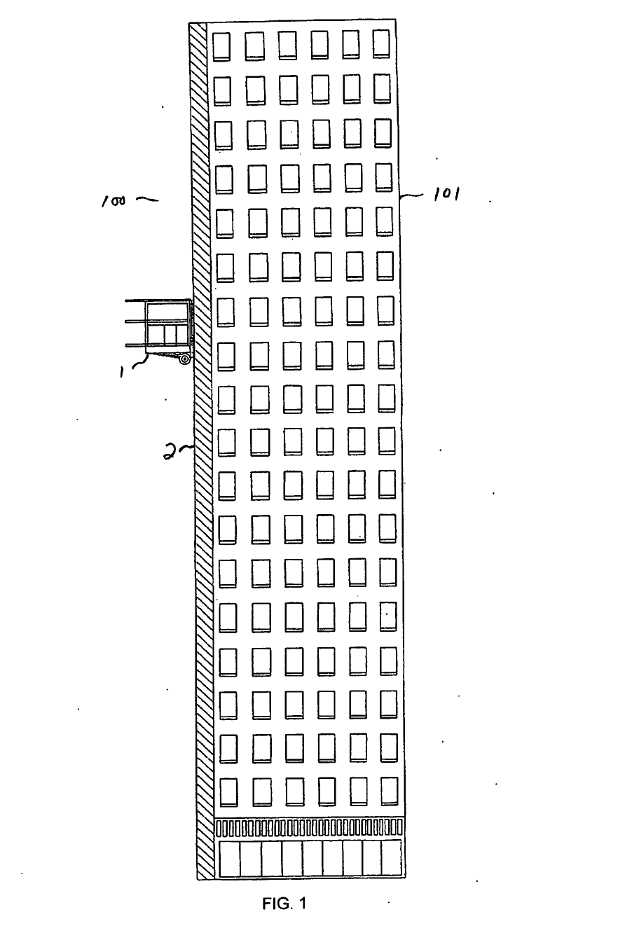

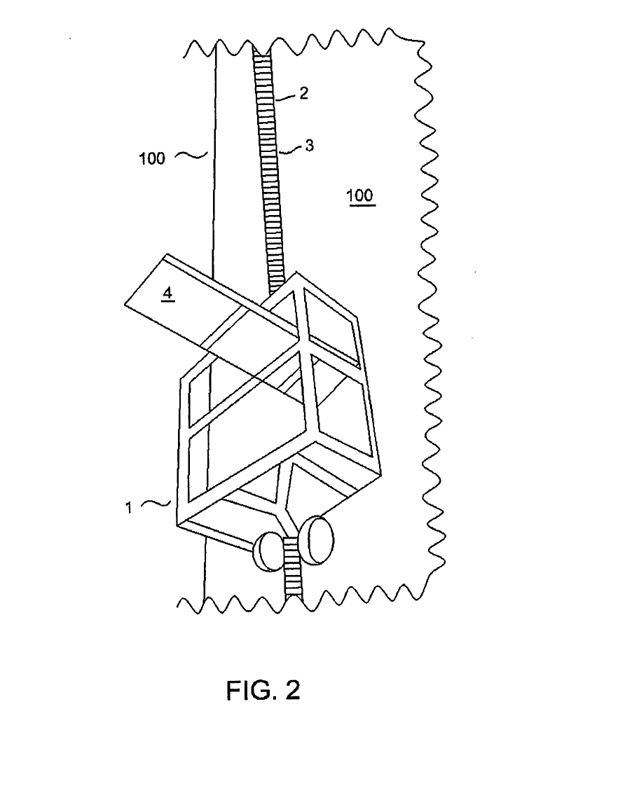

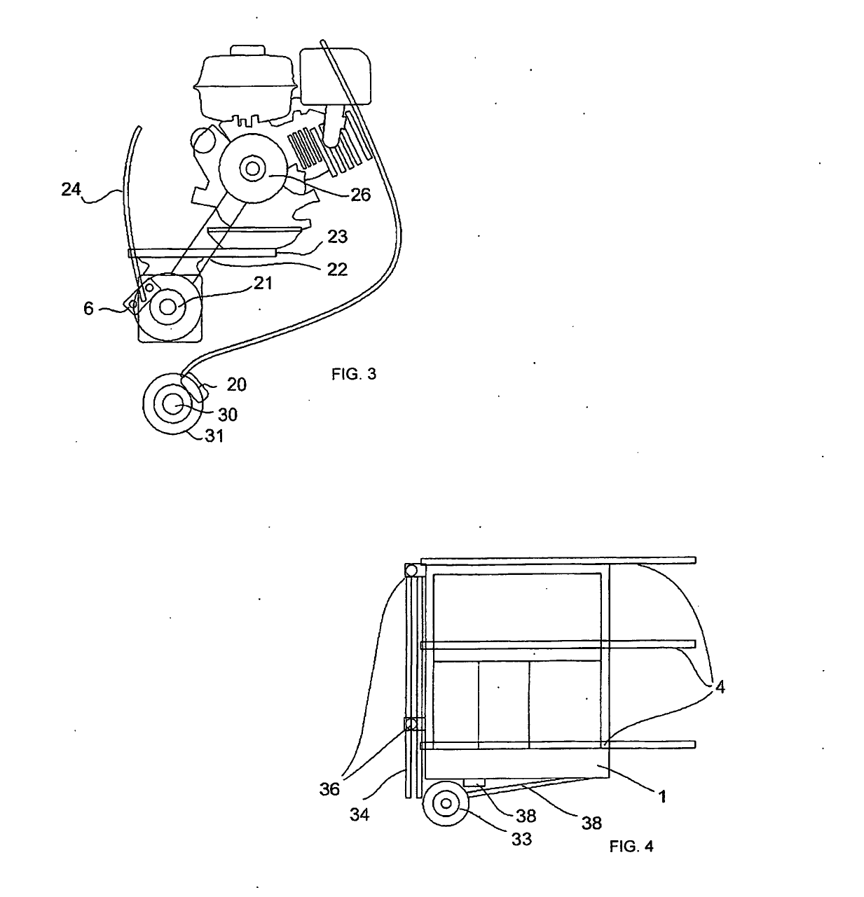

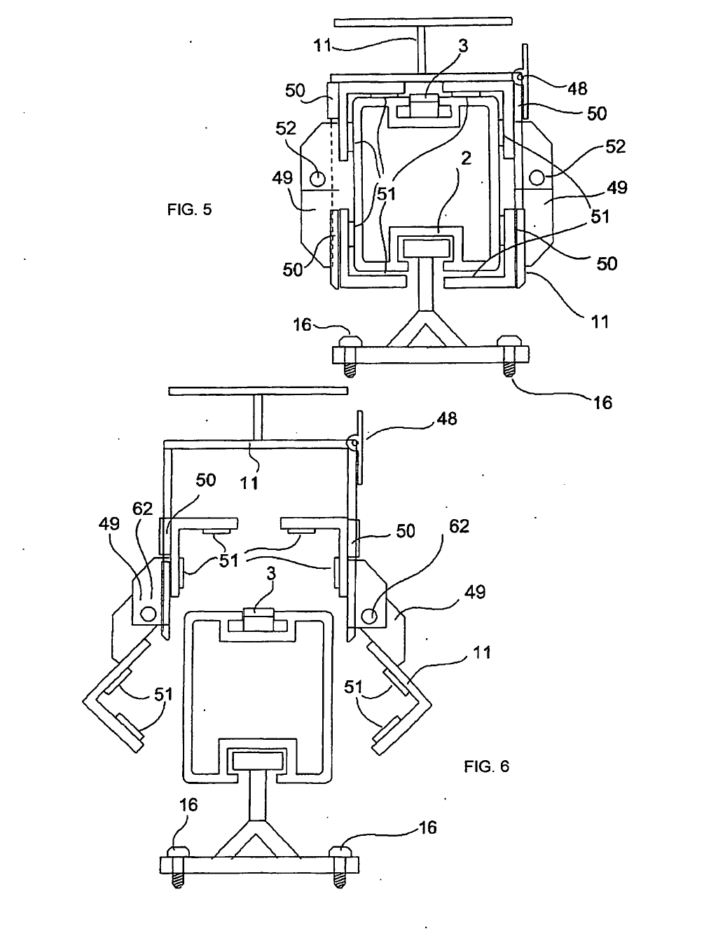

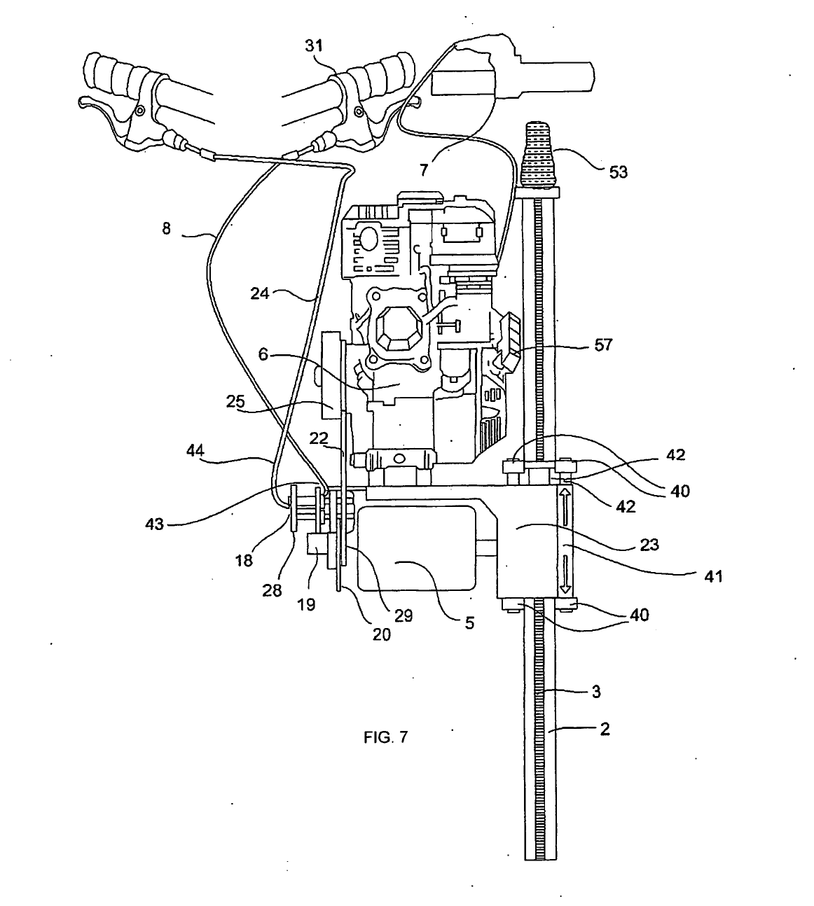

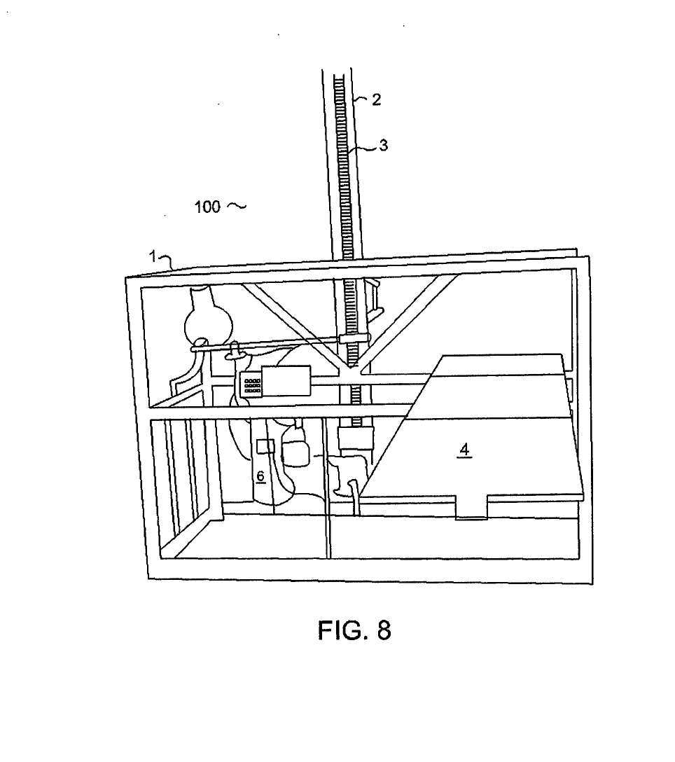

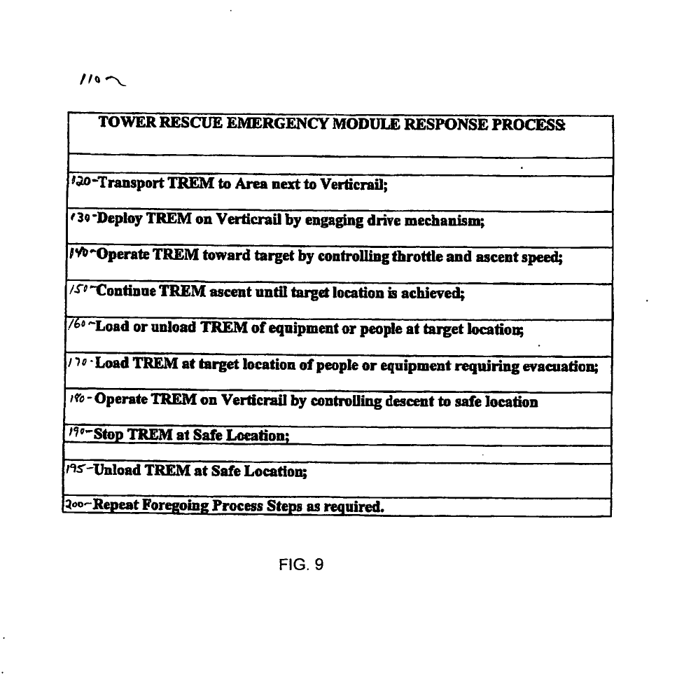

### DETAILED DESCRIPTION OF THE PREFERRED EMBODIMENTS

According to the detailed descriptions given below, a rescue shuttle system for emergency rescue operations at a multi-story building is provided. The system utilizes a vertical rail adapted for mounting on the outer face of a multi-story building upon which a shuttle cab is deployed to rapidly move up and down the vertical rail.

The shuttle cab is propelled thereon by a small lightweight motor controllably engaging the vertical rail and operated by a single person. The cab is configured to carry the operator and one or more passengers or rescue transport gear and is capable of moving expeditiously under emergency conditions. In preferred embodiments, the subject system may include a plurality of vertical rails and shuttles permanently installed on various sides of a high-rise building. The shuttle system is configured to operate at speeds up to about 300 meters per minute.

The system will typically utilize vertical rails and façade mounting anchors made of aluminum and stainless steel components and fasteners. The shuttle typically is powered by a small, lightweight motor, such as a 6.5 hp to 10 hp gas engine with a 12-volt electric starter. A separate manual starter may also be included. The shuttle will have a variable downward speed limited by gravity working with a mechanical braking mechanism to adjust the speed.

For additional control and ease of operation shuttles will preferably incorporate a shaft clutch stop, disc brake and a controllable motor throttle. Similarly, the shuttle may be equipped with a transmission, which is connected to the motor by a transmission chain or belt. The chain can be attached to the motor by a centrifugal clutch and the chain can be attached to the transmission gear wheel and attached to a drive shaft. In the above described system, the shuttle is capable of attaining a height in excess of 600 meters.

In preferred embodiments, the shuttle is made from aluminum and stainless steel. In other preferred embodiments, the shuttle and its drive mechanism are engaged by a shaft gear and a complementary vertical rail gear bar. In certain preferred embodiments, the shuttle may have a plurality of wheels for deploying the shuttle at the vertical rail or removing the shuttle from the vertical rail for storage.

Typically the shuttle can accommodate at least 1,000 pounds and is configured to transport at least six passengers or rescue crew, including personal equipment. Alternatively, the shuttle can be configured to accommodate a plurality of stretchers for injured or handicapped passengers along with the shuttle operator. Optionally, the shuttle may use a strobe light automatically activated by an emergency alarm.

Typically, the shuttle is attached to the vertical rail by a jaw mechanism that opens, closes and locks the shuttle to the rail, and is further comprised of a safety latch.

Accordingly, the subject system provides a safe, efficient and convenient method for tower emergency rescue response. The method will generally comprise the steps of: transporting an emergency shuttle to an area next to a vertical rail securely installed upon the facade of a multi-story building (120); deploying the shuttle on the vertical rail by engaging a drive mechanism (130); operating the shuttle toward a target by controlling throttle and ascent speed (140); continuing shuttle ascent until the target location is achieved (150); loading or unloading the shuttle of equipment or people at the target location (160); loading the shuttle at the target location with people or equipment requiring evacuation (170); operating the shuttle on the vertical rail by controlling descent to a safe location (180); stopping the shuttle at the safe location (190); unloading the shuttle at the safe location (195); and repeating the foregoing steps as required (200).

The subject tower rescue emergency module response process comprises the steps of: transporting the tower rescue shuttle to an area next to the vertirail; deploying the tower rescue shuttle on the vertirail by engaging its drive mechanism; operating the tower rescue shuttle toward a target by controlling throttle and ascent speed; continuing tower rescue shuttle ascent until the target location is achieved; loading or unloading the tower rescue shuttle of equipment or people at target location; loading the tower rescue shuttle at the target location with people or equipment requiring evacuation; operating the tower rescue shuttle on the vertirail by controlling descent to a safe location; stopping the tower rescue shuttle at a safe location; unloading the tower rescue shuttle at a safe location; and repeating the foregoing process steps as required.

In the figures, the following reference numerals are utilized with the respective elements:
shuttle 1;
vertirail 2;
gear bar 3;
stretcher 4;
transmission 5;
motor 6;
throttle 7;
emergency brake 8;
brake 9; to control the shuttle when the shuttle moves downwardly;
hydraulic brake 10;
lock 11; for locking the shuttle to the vertirail;
move out rods for stretcher 12;
fixed bar 13;
bottom lock 14;
wall anchorage 15;
bolts anchorage 16;
building wall 17;
bolts 18; for releasing the down-brake of the shuttle;
shaft transmission 19;
disk brake 20;
clutch bearing 21;
chain 22;
motor and transmission support 23;
brake cable 24; for allowing a shuttle to go down at a controlled speed;
centrifugal clutch 25;
electric starter 26;
hydraulic brake cable 27;
brake cable 28; for permitting the shuttle to go down;
calliper 29;
brake shaft 30;
emergency brake 31;
support for hands control 32;
wheels 33;
vertical column 34;
hydraulic brake 35;
column hinge 36;
strobe light 38;
support reinforcement below the shuttle 39;
rod support 40;
rod cage 41;
springs 42;
hand brake support 43;
brake when the shuttle moves downwardly 44;
springs 45;
fall compression springs 46;
locking bolts to brake when the shuttle moves downwardly 47;
spring lock to vertirail 48;
opening lock 49;
jaw hinge 50;
friction pads affixed inside the rail 51;
jaw opening 52;
strobe light on vertirail top 53;
rods attached to the rescue shuttle that allows the system to float to prevent damage to the shuttle 54;
springs support 55;
lock at the bottom of the vertirail 56; and
manual starter 57.

As seen in the figures, the shuttle 1 is mounted on a vertirail 2. The shuttle is propelled with a small gas engine and the shuttle has an electric starter 26 in addition to a manual starter 57. The shuttle 1 engages a shaft gear married to a vertirail gear bar 3.

The vertirail 2 is attached to the wall anchors 15 which are bolted into the wall face 17. The anchors fit inside the vertirail to allow expansion and avoid being crushed by the oscillation of the building. The shuttle is equipped with wheels 33 and is attached to the vertirail 2 by a jaw 50 that opens and closes and locks (lock 11) the shuttle to the rail with a safety latch.

To allow the shuttle to move along the vertical rail, the shuttle module is equipped with a gas engine with double starter (electric with a key 26 and another recoil type). This self-propelled shuttle is equipped with a transmission, which is connected to the motor 6 by a transmission chain 22. The chain is attached to the motor by a centrifugal clutch 25 and the chain is attached to a transmission gear wheel attached to a drive shaft 60.

The same shaft utilizes a clutch stop and has a disc brake. When the throttle permits the motor to turn fast enough to propel the shuttle, vertical movement occurs and retracting springs allow the shuttle to move along the vertical rail. Also fixed to the support of the transmission and engine are rods 54 which will move slightly in a given axis. With these axes, the shuttle can move vertically with high speed with relatively high loads. The jaws of the shuttle open and close with locks which are blocked by a lock 56 and spring 55.

If desired, to allow the shuttle to move along the vertirail, restriction nodes without pads are attached to the inside of the spine. Levers can be used to operate the shuttle safely. With the throttle cable connected to the engine, the brake lever for emergency response to the shuttle would not necessarily by itself stop the apparatus in descent mode. A second emergency brake is hydraulic and is connected to a disc brake 9 to allow the shuttle to stop safely. Another lever allows the shuttle to descend at the desired speed when pressure is applied to the controller as a brake. This lever is connected by a release system.

When the shuttle stops at the desired height, a systems brake prevents the shuttle from descending accidentally. When pressure is applied to this lever, the shuttle slows down to the desired speed and when the lever is released, the shuttle stops instantly.

A strobe light 38 is fixed under the shuttle to make it visible when the shuttle is moving in the dark. The top of the vertirail will also have a strobe 53 which turns on automatically with the emergency alarm, which permits individuals at risk to be led to the rescue shuttle. Typically, this system will be installed only on a permanent non-powered shuttle bus to be operated by gravity only.

At least three stretchers can fit on a single shuttle rescue along with the operator. There are optional protection rods 54 installed around the shuttle, which can be removed if necessary to install an additional stretcher.

The mechanism of the engine system is connected to the module together with an engine support and transmission. The shuttle and the motor system are fully floating. This means that the movements of the engine via the springs allow the shuttle to rise without damaging the security and safety systems.

It is contemplated that more than one apparatus of the invention can be installed for operation on a building. This is of particular advantage in the case of very tall buildings.

The invention now being fully described, it will be apparent to one of ordinary skill in the art that many changes and modifications can be made thereto without departing from the spirit or scope of the invention set forth herein.

1. A rescue shuttle system for emergency rescue operations at a multi-story building comprising a vertical rail adapted for mounting on the outer face of a multi-story building upon which a shuttle cab is deployed to rapidly move up and down the vertical rail and propelled thereon by a small lightweight motor controllably engaging the vertical rail and operated by a single person; wherein the cab is configured to carry the operator and one or more passengers or rescue transport gear and is capable of moving expeditiously under emergency conditions.

2. The system of claim 1 wherein a plurality of shuttles are permanently installed on various sides of a high-rise building

3. The system of claim 1 wherein the shuttle can accommodate at least 1,000 pounds.

4. The system of claim 1 wherein the shuttle is configured to transport at least six passengers or rescue crew including personal equipment.

5. The system of claim 1 wherein the shuttle is configured to accommodate a plurality of stretchers for injured or handicapped passengers and the shuttle operator.

6. The system of claim 1 wherein the shuttle is configured to operate up to about 300 meters per minute.

7. The system of claim 1 wherein vertical rails and façade mounting anchors are made of aluminum and stainless steel components and fasteners.

8. The system of claim 1 wherein the small lightweight motor is a 6.5 hp to 10 hp gas engine with a 12-volt electric starter.

9. The system of claim 1 wherein variable downward speed is adjusted and limited by gravity and a mechanical braking mechanism to adjust speed.

10. The system of claim 1 further comprising a strobe light automatically activated by an emergency alarm.

11. The system of claim 1 wherein the shuttle is made from aluminum and stainless steel.

12. The system of claim 1 wherein the shuttle engine further comprises a manual starter.

13. The system of claim 1 wherein the shuttle and its drive mechanism are engaged by a shaft gear and a complementary vertical rail gear bar.

14. The system of claim 1 wherein the shuttle is further comprised of a plurality of wheels for deploying the shuttle at the vertical rail or removing the shuttle from the vertical rail for storage.

15. The system of claim 1 wherein the shuttle is attached to the vertical rail by a jaw mechanism that opens, closes and locks the shuttle to the rail, and is further comprised of a safety latch.

16. The system of claim 1 further comprising a shaft clutch stop, disc brake and a controllable motor throttle.

17. The system of claim 1 wherein the shuttle is equipped with a transmission, which is connected to the motor by a transmission chain, wherein the chain is attached to the motor by a centrifugal clutch and the chain is attached to a transmission gear wheel attached to a drive shaft.

18. The system of claim 1 wherein the shuttle is capable of attaining a height in excess of 600 meters.

19. A method for tower emergency rescue response process comprising the steps of:
transporting an emergency shuttle to an area next to a vertical rail securely installed upon the façade of a multi-story building; deploying the shuttle on the vertical rail by engaging a drive mechanism; operating the shuttle toward a target by controlling throttle and ascent speed; continuing shuttle ascent until the target location is achieved; loading or unloading the shuttle of equipment or people at the target location; loading the shuttle at the target location with people or equipment requiring evacuation; operating the shuttle on the vertical rail by controlling descent to a safe location; stopping the shuttle at the safe location; unloading the shuttle at the safe location; and repeating the foregoing steps as required.
